(19) United States
(12) Patent Application Publication
(10) Pub. No.: US 2012/0124038 A1
(43) Pub. Date: May 17, 2012

(54) Variable Length Snippet Generation

(76) Inventor: Paul Buchheit, Mountain View, CA (US)

(21) Appl. No.: 13/356,467

(22) Filed: Jan. 23, 2012

Related U.S. Application Data
(63) Continuation of application No. 10/866,466, filed on Jun. 9, 2004, now abandoned.

(51) Int. Cl. G06F 17/30

(52) U.S. Cl. 707/723; 707/E17.084

(57) ABSTRACT

A computer system includes one or more processors and memory. The system receives a search query from a client, and obtains a search result for the search query comprising a list of matching email documents. The system, for each email document in the list of matching email documents, determines a scatter score indicating how scattered search terms of the search query are within a respective email document, selects a text portion of the respective email document in accordance with query terms of the search query and the scatter score for the respective email document, and generates a respective snippet including the selected text portion. The system transmits the search result to the client, the transmitted search result including the snippet for each email document in the list of matching email documents.

### RELATED APPLICATION

This application is a continuation of U.S. patent application Ser. No. 10/866,466, filed on Jun. 9, 2004, entitled “Variable Length Snippet Generation,” which is incorporated by reference in its entirety.

### TECHNICAL FIELD

The present invention relates generally to producing search results for use in computer network systems, and in particular to producing search results with snippets of text.

### BACKGROUND

A search engine is a software program designed to help a user access files stored on a computer, for example on the World Wide Web (WWW), by allowing the user to ask for documents meeting certain criteria (e.g., those containing a given word, a set of words, or a phrase) and retrieving files that match those criteria. Web search engines work by storing information about a large number of web pages (hereinafter also referred to as “pages” or “documents”), which they retrieve from the WWW. These documents are retrieved by a web crawler or spider, which is an automated web browser which follows every link it encounters in a crawled document. The contents of each document are indexed, thereby adding data concerning the words or terms in the document to an index database for use in responding to queries. Some search engines, also store all or part of the document itself, in addition to the index entries. When a user makes a search query having one or more terms, the search engine searches the index for documents that satisfy the query, and provides a listing of matching documents, typically including for each listed document the URL, the title of the document, and in some search engines a portion of document's text deemed relevant to the query. This portion of the document's text is known as a snippet and serves to aid the user in determining whether the document is of interest to the user.

### SUMMARY

A method that varies a snippet length in returned search results based on an estimate of how much of the document a user might need before identifying the document as one of interest. Some embodiments examine parameters associated with a document to determine an appropriate snippet length. For example, a document's age could be used to determine snippet length. The older a document is, the longer the desired snippet length for the document. Some embodiments examine parameters associated with a document as a result of a search query. For example, a query score could also be used to determine snippet length. The lower the query score the longer the desired snippet desired for the document.

### BRIEF DESCRIPTION OF THE DRAWINGS

For a better understanding of the nature and embodiments of the invention, reference should be made to the Description of Embodiments below, in conjunction with the following drawings in which like reference numerals refer to corresponding parts throughout the figures.

FIG. 1 is a schematic diagram of a system that generates variable length snippets in accordance with an embodiment of the present invention.

FIG. 2 is a flow chart for producing variable length snippets on a set of search results in accordance with an embodiment of the present invention.

FIG. 3 is a flow chart for producing a variable length snippet in accordance with an embodiment of the present invention.

FIG. 4 is a schematic screen shot of portion of an exemplary user interface for an electronic mail program in accordance with an embodiment of the present invention.

FIG. 5 is a flow chart for producing variable length snippets in response to a search query in accordance with an embodiment of the present invention.

FIG. 6 is schematic representation of a snippet data structure in accordance with an embodiment of the present invention.

FIG. 7 is a block diagram of an exemplary system that generates a variable length snippet in accordance with an embodiment of the present invention.

### DESCRIPTION OF EMBODIMENTS

When a user enters a search request, a number of documents may match the search query with varying degrees of certainty. Snippets of text surrounding a portion of the document matching the search query are routinely provided by search systems to aid the user in selecting a desired document. In situations where the search query matches a document with a high degree of certainty, the user may not need a large snippet to determine that the document is of interest to the user. On the other hand, if the document does not match the search query with a high level certainty, the user may need a larger snippet to determine whether the document is of interest. In another example, where a user may be somewhat familiar with a set of documents against which a search is run, it may be helpful to generate a snippet length based on an estimate how likely the user will recognize the document. For example, if a search is run against a user's e-mail, it is likely that the user is more familiar with recently viewed e-mail than e-mail which have not been viewed or were received some time ago. In the former case, shorter snippets may suffice, but in the latter case, the user is likely to need more text to jog the user's memory regarding a particular e-mail. Accordingly, a system which has the ability to generate a variable snippet length would be desirable.

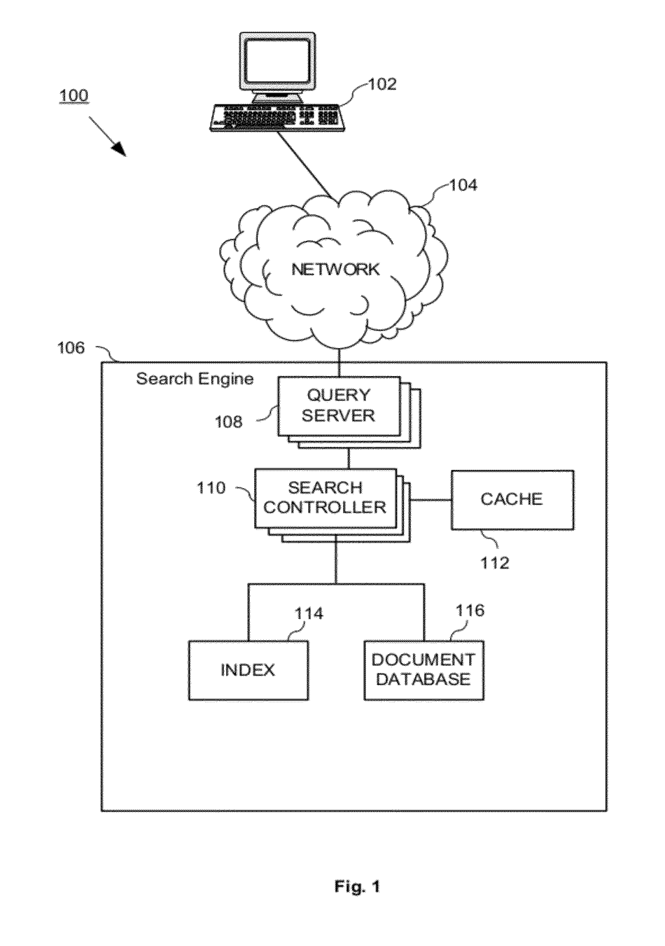

FIG. 1 illustrates a system 100 which has the ability to generate variable snippet lengths in response to a search request. One of ordinary skill in the art will recognize that the concepts of those embodiments of the invention described herein may take on other suitable layouts or configurations without departing from their scope. The system 100 includes a client 102, a network 104, and a search engine 106. The client 102 is connected to the search engine 106 via the network 104. A user enters a search request into a client application (not shown) running on client 102. The client application transmits the search request to the search engine 106 for processing. The search engine 106 includes a query server 108, a search controller 110, a cache 112, an index 114, and a document database 116. In some embodiments, the components of the search engine 106 are deployed over multiple computers in order to provide fast access to a large number of cached documents. For example, the document database 116 may be deployed over N servers, with a mapping function such as the “modulo N” function being used to determine which documents are stored in each of the N servers. N may be an integer greater than 1, for instance an integer between 2 and 1024. Similarly, the index 114 may be distributed over multiple servers, and the cache 112 may also be distributed over multiple servers. For convenience of explanation, we will discuss the components of search engine 106 as though they were implemented on a single server.

The search controller 110 is coupled to the query server 108. The search controller 110 is also coupled to the cache 112, the document index 116 and the document database 116. The search controller 110 is configured to receive requests from the query server 108 and transmit the requests to the cache 112, the document index 114, and the document database 116. The cache 112 is used to increase search efficiency by temporarily storing previously located search results.

The search controller 110 receives the search results from the cache 112 and/or the document index 114 and constructs an ordered search result list. If the search controller 110 does not receive all the required search results information from the cache 112, it may transmit to the document database 116 a request for snippets of an appropriate subset of the documents in the ordered search list. The request for snippets may include one or more parameters concerning snippet length. For instance, the search controller 110 may request snippets for the first fifteen or so of the documents in the ordered search result list. The document database 116 constructs snippets based on the search query and the desired snippet length, and returns the snippets to the search controller 110. The search controller 110 then returns a list of located documents and snippets back to the query server 108 for onward transmittal to the client 102.

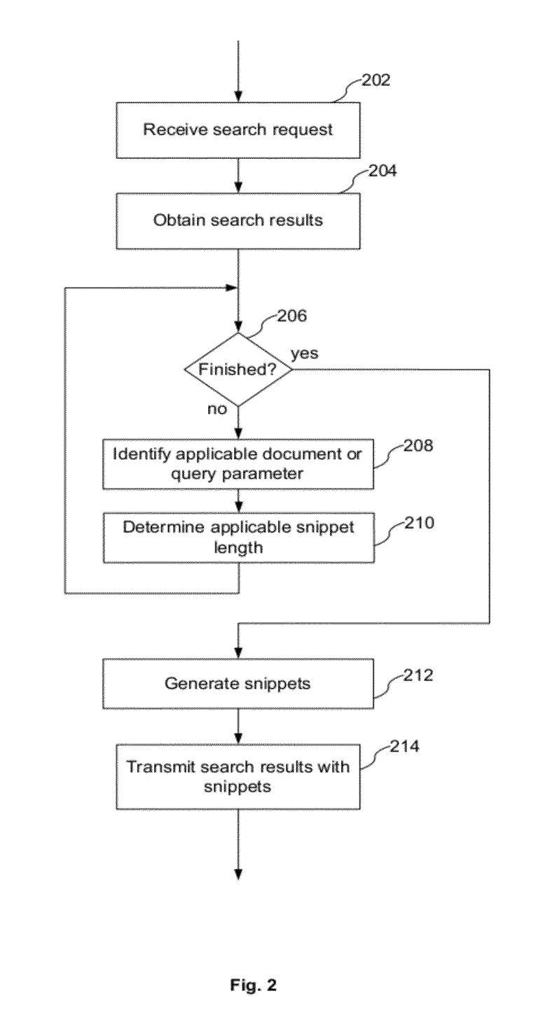

Referring to FIG. 2, an embodiment for generating snippets of variable length is explained. As mentioned above, the query server 108 receives a search request (stage 202) which it transmits to the search controller 110. The search controller 110 obtains the search results and creates a search results list (stage 204). For a number of the search results (stage 206), the search controller 110 identifies certain document or query parameters (stage 208) which may aid in determining a desired length of a snippet from that document (stage 210). After the applicable desired snippet lengths are determined, the search controller 110 uses the document database 116 to generate the snippets (stage 212). The query server 108 transmits the list of documents with the snippets to the client 102 (stage 214).

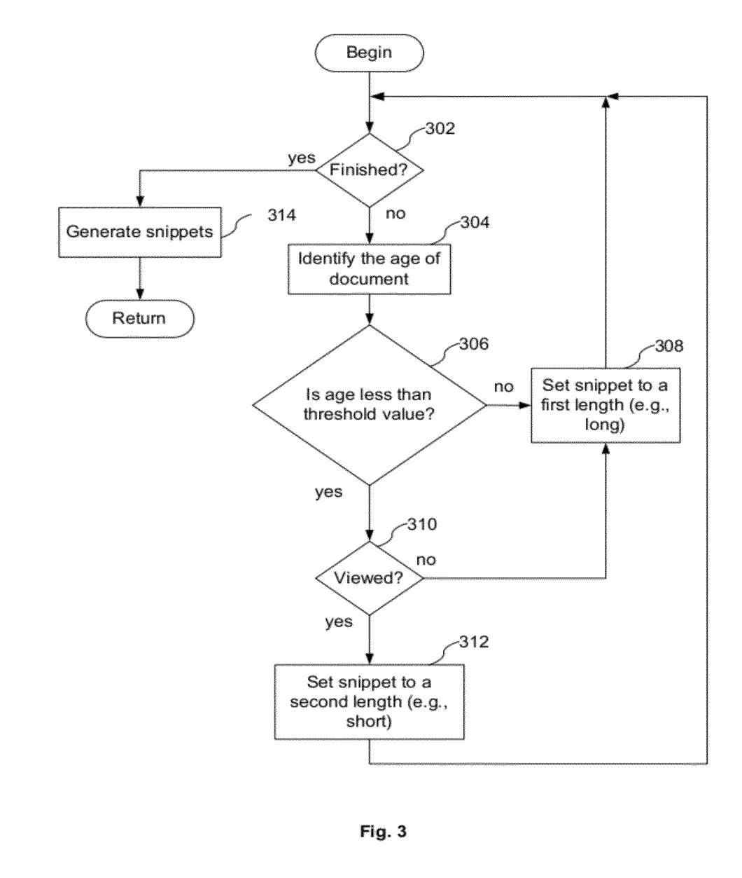

FIG. 3 illustrates one embodiment of using certain document or query parameters to generate a snippet length which varies depending on those document or query parameters. In this instance, FIG. 3 illustrates an embodiment using a document's age in making the desired snippet length determination. While there are still snippet lengths to set (stage 302), the document's age is identified (stage 304). There are a number of different document parameters that may be used to identify a document's age including, without limitation, a creation date, a last modified date, a date provided by the document's host server, a received date or other date or time fields which might be used to compare documents in time. In this embodiment, when the age of the document is greater than or equal to a threshold value (stage 306-no), then the snippet length for the document is set to be a first length (stage 308). When implemented as part of an e-mail application, this condition might be met when a document is equal to or over 30 days old, for example. In such a situation, it is more likely that the user might not immediately recognize the contents of the older document and therefore the snippet should be of some size larger than for more recent documents. The snippet length for those documents aged 30 days and over might be 120 characters, whereas a snippet length for documents under 30 days of age might be 50 characters.

If the age of the document is less than the threshold value (stage 306-yes), then, optionally, a determination is made regarding whether the document has been viewed (stage 310). This optional determination might be useful in an e-mail application, for example, because a document that has not been viewed would be unfamiliar to the user and therefore, it would be more helpful to the user if more text was provided in the snippet when returned from a search as compared to more familiar documents. Accordingly, when the document has not yet been viewed, the snippet length is set to the first length (stage 308). If the document had been viewed (stage 310-yes) and its age is less than the threshold value (stage 306-yes), then the snippet length is set to a second length (stage 312) which may, for example, be shorter than the first length. In this situation, the likelihood is increased that the user will recognize the document and will therefore be able to make a determination of whether it is of interest based on a snippet of a shorter length.

The threshold value may be chosen based on a number of factors, including without limitation, a past rolling window of the frequency of documents over time. As the frequency of documents increases within a time period, a user might begin to forget documents more quickly and therefore the threshold could be reduced. For example, during the months leading up to an accountant's tax filing deadlines, it may be useful to provide longer snippets after an e-mail becomes 10 days old than during a off-peak time where the threshold might be set at 30 days. Those of ordinary skill in the art will recognize many ways to use this feature of an age threshold in determining a snippet length. Although a document of an e-mail type was used as one example in reference to FIG. 3, the term document as used throughout this description of embodiments includes, without limitation, Web pages, graphics, audio, video, and other data structures and data files. Additionally, although this description uses an exemplary user and client application, one could envision other ways in which snippets of documents are produced for consumption by other applications or generated for other purposes that may or may not include a user or client application. After the applicable snippet lengths have been determined (stage 302-yes), the snippets are generated (stage 314) using the document database.

Although the flow chart in FIG. 3 describes a threshold value, this is just a special case of setting the snippet length as a function of the document's age. Other embodiments may apply a function that correlates a snippet length to a document's age such that as the age of the document increases, so would a desired snippet length for the document. One such function might be a linear one between the age and the resulting snippet length. Another might allow for grouping of dates wherein documents within a certain age range receive snippet lengths associated with the particular range into which it falls. Ranges with ages further out in time would have longer snippet lengths.

Even setting a snippet length as a function of the document's age is just a specialized case of determining a snippet length based on a feature or parameter of a document, independent from those which might be generated as part of applying a search query to the document. For example, other types of document parameters might include the type of document, e.g., e-mail, audio, video, and so on. They could also include location information about from where the document originated, e.g., legal sites, medical sites, and so on. They could also include, for example, the language of the document or the owner or creator of the document. They could also include the last time the user viewed or examined the document. One of ordinary skill in the art would readily recognize other document parameters which could be used to vary a snippet length and various relationships between that parameter and the length of the snippet such that varying the snippet length will increase the likelihood of the user being able to recognize from the snippet whether a document will be of interest to the user.

Snippet lengths can also be set depending on information generated as part of applying a search query to a document or sets of documents. Such information might include, without limitation, query scores, scatter information, or document popularity for example. A query score is generally indicative of how well a search query matched against a particular document. A higher score usually indicates a better match. Typically a query score is based on a numerical analysis of the occurrences of the query search terms or phrases. For example, a document that contains a search term 20 times would have a higher score than a document that contained the search term only 5 times (assuming comparable placements of the search term in the documents). In more complex scoring schemes, the score may be affected by relationships between the words and phrases. Additionally weights may be applied to the various elements of the search query to weight some elements more than others. Many types of query scoring are well known.

As with a document's age, the query score could be used in a number of ways to affect snippet length. Documents which generate scores below a threshold could have longer snippet lengths since those document would not match the search query as well as those documents with higher query scores, and thus it would be helpful to the user in identifying interesting documents to present longer snippets of the low scoring documents. Snippet lengths could correspond to ranges of query scores with longer snippet lengths set for ranges that include lower query scores than ranges which include higher query scores. Snippet lengths could be based on any number of functions that inversely relate a query score to a snippet length, thereby providing longer snippet lengths for lower query scores that indicate a waning of the match of the query to the document. A popularity ranking could also be used in this manner. Documents that are popular may deal with topics and issues for which the user may already be familiar, whereas less popular documents may be of interest to the user but the user will need a longer snippet to make such a determination.

Scatter information could also be provided and used to affect snippet length. A scatter score could be used to indicate how scattered the search terms are within a document. The more scattered the search terms are in the document, the more likely that the user would benefit from being able to see a longer snippet in the search results. As before, the relation between snippet length and score could be based on a generalized function, a threshold value, or a range of scores. Based on the explanations in this document, those skilled in the art will recognize other ways that a scatter score, or other types of parameters, could affect snippet length.

The snippet length could also be based on taking into consideration one or more characteristics of the search results as a whole or a subset of the results and then applying the resulting snippet length to all documents in the search result. For example, if the median age of the documents returned from a search result was older than a predetermined date, say 30 days, then all snippets would be generated with the longer snippet length. One of ordinary skill in the art would recognize how other characteristics of a search result could be similarly used without departing from the scope of embodiments of the invention.

The document or query properties described herein are not directly related to a document's length (though a document's length could be a factor in some query scoring schemes). Instead, the embodiments described herein determine a desirable snippet length which is independent of the document's length and likely to aid the user. The snippet length is then used to create the snippets from the documents. The fact that a document's length may be less than the desired snippet length does not affect determining the desired snippet length. It may, however, result in smaller snippets being ultimately created when the amount of available for snippets is less than the desired snippet length.

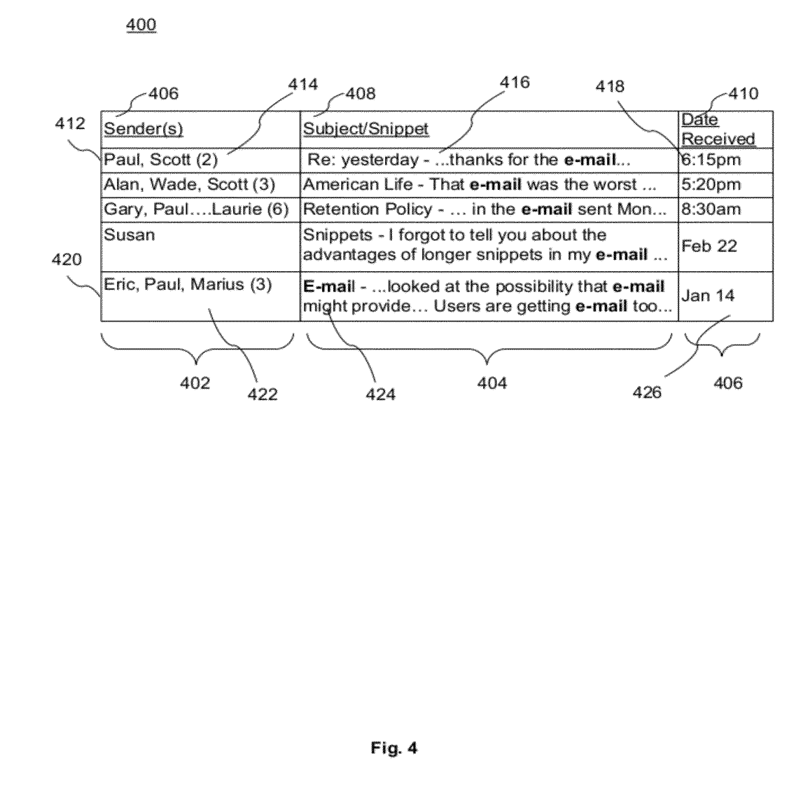

In certain situations, it may be desirable to alter the presentation of snippets based on the snippet length. Different formatting features may be associated with different snippet lengths. Referring to FIG. 4, a portion of an exemplary user interface 400 for an electronic mail (e-mail) program is shown. The user interface 400 includes a sender column 402, a subject/snippet column 404, and a date received column 406. In the first cell of each column 402, 404, 406 is the column's associated label. The sender column 402 includes sender label 406, the subject/snippet column 404 includes subject/snippet label 408, and the date received column 406 includes a date received label 410. Each email displayed in the interface 400 includes one entry in each of columns 402, 404, and 406. For example, the inbox user interface 400 displays an e-mail 412 which includes a sender list 414, a subject/snippet 416 wherein the subject is separated from the snippet by a “−” character, and a date 418 at which the e-mail was received. A second email 420 is also displayed which includes a sender list 422, a subject/snippet 424 wherein the subject is separated from the snippet by a “−” character, and a date 426 at which the e-mail was received. In this instance a threshold value of 30 days determines whether a short snippet or a long snippet is used.

As can be seen in reference to FIG. 4 and assuming a current date of June 9, the snippets having only a time value in the date column 406 are indicative of having been received on the current date whereas those dates represented by a month and day were received prior to the current date. For example, the e-mail 412 was received at 6:15 pm of the current date while the e-mail 420 was received January 14th—more than 30 days ago. Accordingly, with a threshold of 30 days, the e-mail 420 would have a longer snippet length associated with it than the e-mail 412. In addition to a longer snippet length, the information associated with the snippets may indicate differences in presentation. For example, the shorter snippet associated with e-mail 412 is represented on a single row or line of the display, whereas the longer snippet associated with the e-mail 420 may be shown in its entirety. In such a situation, the formatting information associated with a longer snippet, such as for e-mail 420, might include information which allows the longer snippet to have the text “wrapped” to fit in the display area and thus expanding to more than one line or row, whereas the formatting information associated with the shorter snippet would not allow “wrapping” and remains on a single row or line, with whatever portion of the snippet which cannot be displayed due to the size of the window being represented by “ . . . ” or just not displayed at all. One or ordinary skill in the art would recognize may other ways to format snippets of different lengths without departing from the scope of the invention.

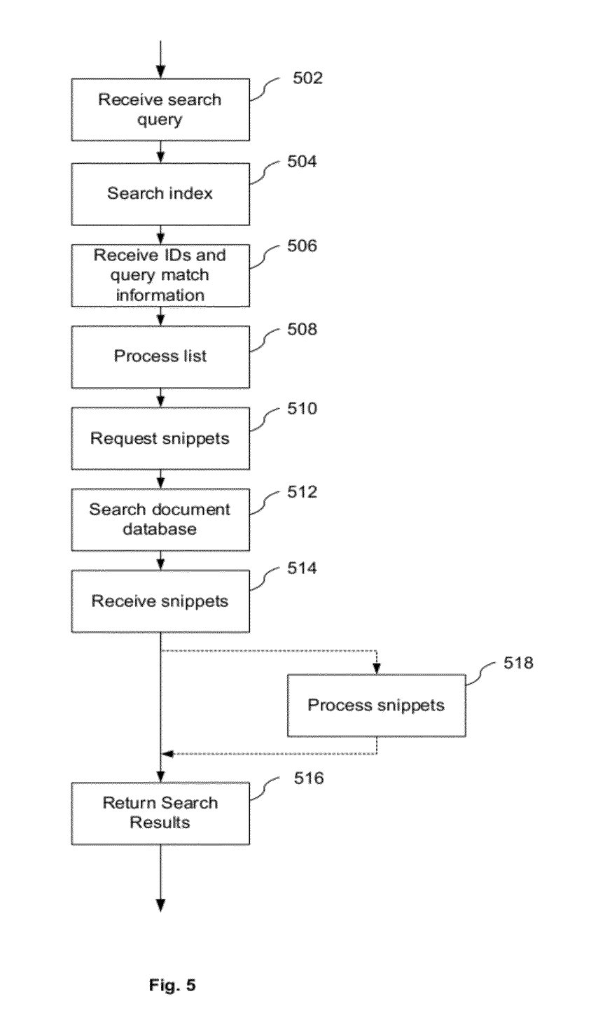

Referring to FIG. 5, a more detailed discussion of the snippet generation is provided according to an embodiment of the invention. After a search request is received (stage 502) at, for example, a query server, the index of documents is searched to generate a list of documents that match the search query (stage 504). A list of document is received by, for example, the search controller along with query match information such as a query score (stage 506). The list is then processed to, for example, sort the list of document identifiers, truncate the list to only include a predetermined amount of document identifiers, such as the top 1000 documents, eliminate duplicates from the list, and/or remove non-relevant document identifiers (stage 508). Snippets for all or a portion of the documents on the list may be requested (stage 510) which includes identifying the applicable snippet length as described elsewhere according to the various embodiments of the invention. The document database is then searched (stage 512) to obtain the snippets associated with the desired snippet lengths in the identified documents, which are then subsequently received at, for example, the search controller (stage 514). The received snippets are then returned to the search requestor (stage 516). In an alternative embodiment, instead of providing a desired snippet length when the snippets are requested from the document database, the document database returns snippets of the longest length desired and then reduces the snippet length as appropriate after the long snippets are returned (stage 518). In other words, full length snippets are shortened at stage 518 in accordance with any of the criteria or functions described above. In another alternative embodiment the processing 518 could take place on the client 102. It should be noted that the stages of the process shown in FIG. 5 may be performed in many computational contexts, including computational contexts quite different from the one shown in FIG. 1.

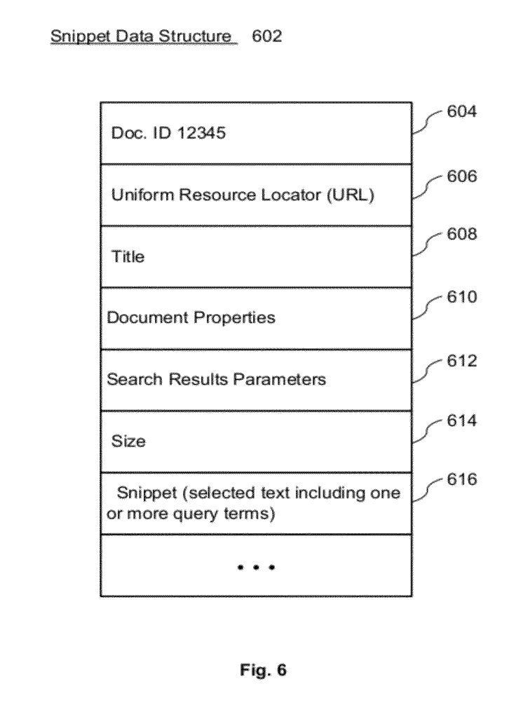

FIG. 6 illustrates an exemplary snippet data structure 602. The snippet data structure 602 may contain: a document ID 604 which identifies the particular document; a uniform resource locator (URL) 606 which provides information about from where the document originated; a title 608 of the document; document properties 610 which may include such information as the dates of creation, last modification, last viewing, and other information about the document; search results parameters 612 which may describe, for example, how well the document matched the search query, how scattered the search terms are in the document, a document's query score, or a document's popularity expressed as a page rank; a size 614 of the document; and snippet 616 (selected text including one or more query terms).

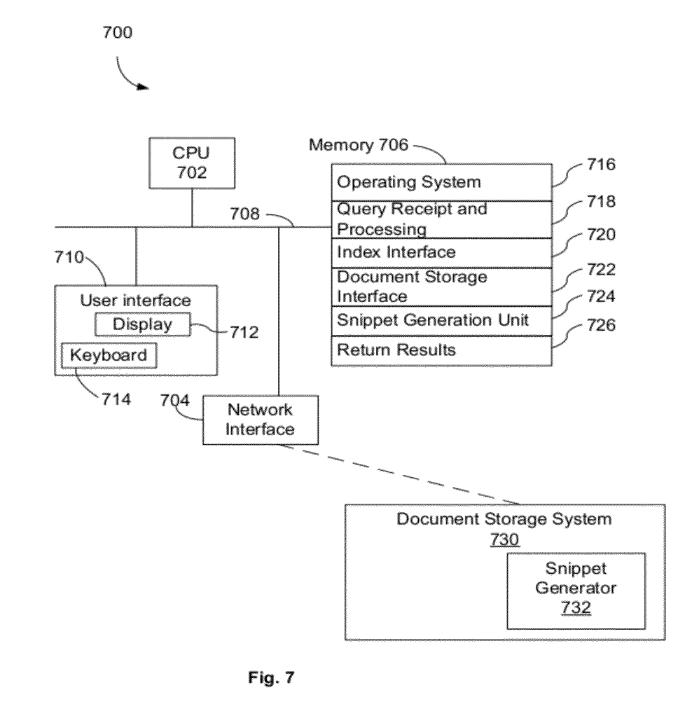

Referring to FIG. 7, an embodiment of a system 700 that implements the methods described above includes one or more processing units (CPU's) 702, one or more network or other communications interfaces 704, memory 706, and one or more communication buses 708 for interconnecting these components. The system 700 may include a user interface 710 comprising a display device 712 and/or a keyboard 714. Memory 706 may include high speed random access memory and may also include non-volatile memory, such as one or more magnetic or optical storage disks. Memory 706 may include mass storage that is remotely located from CPU's 702. The memory 706 may store:
an operating system 716 that includes procedures for handling various basic system services and for performing hardware dependent tasks;
a query receipt and processing unit 718 for receiving a query and processing information about the query;
an index interface 720 for interfacing with an index when searching for documents;
a document storage interface 722 for interfacing with a document storage system for requesting and receiving snippets;
a snippet generation unit 724 that determines an applicable or desired snippet length based on certain conditions as described above; and
a return results unit 726 for returning the search result with the associated snippets to the search requestor.

The system 700 also includes a document storage system 730 for storing the content of the documents which are searched. The document storage system 730 includes a snippet generator 732 for accessing the documents and generating snippets of predetermined lengths.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for producing search results, comprising:
at a computer system having one or more processors and memory storing instructions for execution by the one or more processors:
receiving a search query from a client;
obtaining a search result for the search query comprising a list of matching email documents;
for each email document in the list of matching email documents:
determining a scatter score indicating how scattered search terms of the search query are within a respective email document;
selecting a text portion of the respective email document in accordance with query terms of the search query and the scatter score for the respective email document; and
generating a respective snippet including the selected text portion; and
transmitting the search result to the client, the transmitted search result including the snippet for each email document in the list of matching email documents.

2. The method of claim 1, further comprising:
determining, for each email document in the list of matching email documents, a query score based a number of occurrences of the search terms of the search query within the respective email document,
wherein selecting the text portion of the respective email document includes selecting a text portion in accordance with the query score for the respective email document.

3. The method of claim 1, further comprising:
determining, for each email document in the list of matching email documents, a document age,
wherein selecting the snippet includes selecting a text portion in accordance with the document age of the respective email document.

4. The method of claim 3, wherein a first snippet comprising a text portion of a first email document that has a first document age has a first length and a second snippet comprising a text portion of a second email document that has a second document age is selected so that the second snippet has a second length longer than the first length of the first snippet when the second document age is older than the first document age.

5. The method of claim 1, further comprising selecting the text portion of the respective email document in accordance with a representative document age of the matching email documents.

6. The method of claim 1, wherein the transmitted search result includes information for display at the client in at least three columns and a set of rows, each row corresponding to an email document in the list of matching email documents, the at least three columns including:
a column to display text identifying one or more senders for each email document in the list of matching email documents,
a column to display a date or time of receipt for each email document in the list of matching email documents, and
a column to display a snippet for each email document in the list of matching email documents.

7. The method of claim 1, wherein the transmitted search result includes information for formatting each snippet for display, information for formatting a first respective snippet includes information for limiting display to a single line, and information for formatting a second respective snippet includes information for permitting display on multiple lines.

8. A computer system, comprising:
one or more processors; and
memory storing one or more programs for execution by the one or more processors, the one or more programs including instructions for:
receiving a search query from a client;
obtaining a search result for the search query comprising a list of matching email documents;
for each email document in the list of matching email documents:
determining a scatter score indicating how scattered search terms of the search query are within a respective email document;
selecting a text portion of the respective email document in accordance with query terms of the search query and the scatter score for the respective email document; and
generating a respective snippet including the selected text portion; and
transmitting the search result to the client, the transmitted search result including the snippet for each email document in the list of matching email documents.

9. The system of claim 8, wherein the one or more programs include instructions for:
determining, for each email document in the list of matching email documents, a query score based a number of occurrences of the search terms of the search query within the respective email document,
wherein selecting the text portion of the respective email document includes selecting a text portion in accordance with the query score for the respective email document.

10. The system of claim 8, wherein the one or more programs include instructions for:
determining, for each email document in the list of matching email documents, a document age,
wherein selecting the snippet includes selecting a text portion in accordance with the document age of the respective email document.

11. The system of claim 10, wherein a first snippet comprising a text portion of a first email document that has a first document age has a first length and a second snippet comprising a text portion of a second email document that has a second document age is selected so that the second snippet has a second length longer than the first length of the first snippet when the second document age is older than the first document age.

12. The system of claim 8, wherein the one or more programs include instructions for selecting the text portion of the respective email document in accordance with a representative document age of the matching email documents.

13. The system of claim 8, wherein the transmitted search result includes information for display at the client in at least three columns and a set of rows, each row corresponding to an email document in the list of matching email documents, the at least three columns including:
a column to display text identifying one or more senders for each email document in the list of matching email documents,
a column to display a date or time of receipt for each email document in the list of matching email documents, and
a column to display a snippet for each email document in the list of matching email documents.

14. The method of claim 1, wherein the transmitted search result includes information for formatting each snippet for display, information for formatting a first respective snippet includes information for limiting display to a single line, and information for formatting a second respective snippet includes information for permitting display on multiple lines.

15. A non-transitory computer readable storage medium storing one or more programs for execution by one or more processors of a computer system, the one or more programs including instructions for:
receiving a search query from a client;
obtaining a search result for the search query comprising a list of matching email documents;
for each email document in the list of matching email documents:
determining a scatter score indicating how scattered search terms of the search query are within a respective email document;
selecting a text portion of the respective email document in accordance with query terms of the search query and the scatter score for the respective email document; and
generating a respective snippet including the selected text portion; and
transmitting the search result to the client, the transmitted search result including the snippet for each email document in the list of matching email documents.

16. The computer readable storage medium of claim 15, wherein the one or more programs include instructions for:
determining, for each email document in the list of matching email documents, a query score based a number of occurrences of the search terms of the search query within the respective email document,
wherein selecting the text portion of the respective email document includes selecting a text portion in accordance with the query score for the respective email document.

17. The computer readable storage medium of claim 15, wherein the one or more programs include instructions for:
determining, for each email document in the list of matching email documents, a document age,
wherein selecting the snippet includes selecting a text portion in accordance with the document age of the respective email document.

18. The computer readable storage medium of claim 17, wherein a first snippet comprising a text portion of a first email document that has a first document age has a first length and a second snippet comprising a text portion of a second email document that has a second document age is selected so that the second snippet has a second length longer than the first length of the first snippet when the second document age is older than the first document age.

19. The computer readable storage medium of claim 15, wherein the one or more programs include instructions for selecting the text portion of the respective email document in accordance with a representative document age of the matching email documents.

20. The computer readable storage medium of claim 15, wherein the transmitted search result includes information for display at the client in at least three columns and a set of rows, each row corresponding to an email document in the list of matching email documents, the at least three columns including:
a column to display text identifying one or more senders for each email document in the list of matching email documents,
a column to display a date or time of receipt for each email document in the list of matching email documents, and
a column to display a snippet for each email document in the list of matching email documents.
